(19) United States
(12) Patent Application Publication
(10) Pub. No.: US 2025/0338179 A1
(43) Pub. Date: Oct. 30, 2025

(54) APPARATUS AND METHOD FOR CONDITIONAL LOWER LAYER TRIGGERED MOBILITY IN WIRELESS COMMUNICATION SYSTEM

(71) Applicant: Samsung Electronics Co., Ltd., Suwon-si (KR)

(72) Inventors: June HWANG, Suwon-si (KR); Seungri JIN, Suwon-si (KR)

(21) Appl. No.: 19/169,454

(22) Filed: Apr. 3, 2025

(30) Foreign Application Priority Data
Apr. 29, 2024 (KR) 10-2024-0056923
Jul. 15, 2024 (KR) 10-2024-0093322

(51) Int. Cl. H04W 36/00; H04B 7/06

(52) U.S. Cl. CPC H04W 36/0058; H04B 7/06952; H04W 36/0072

(57) ABSTRACT

The disclosure relates to a 5G or 6G communication system for supporting a higher data transmission rate. A method performed by a user equipment (UE) in a wireless communication system is provided. The method includes receiving, from a base station on a serving cell, configuration information on a conditional lower layers triggered mobility (CLTM), performing a measurement on cells, based on the configuration information, and performing a handover to one cell of the cells, based on a result of the measurement.

CROSS-REFERENCE TO RELATED APPLICATION(S)

This application is based on and claims priority under 35 U.S.C. § 119(a) of a Korean patent application number 10-2024-0056923, filed on Apr. 29, 2024, in the Korean Intellectual Property Office, and of a Korean patent application number 10-2024-0093322, filed on Jul. 15, 2024, in the Korean Intellectual Property Office, the disclosure of each of which is incorporated by reference herein in its entirety.

### BACKGROUND

### 1. Field

The disclosure relates to moving operations of a conditional mobility user equipment (UE) in a wireless communication system. More particularly, the disclosure relates to conditional mobility.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as mm Wave including 28 GHz and 39 GHz. In addition, it has been considered to implement sixth generation (6G) mobile communication technologies (referred to as Beyond 5G systems) in terahertz (TH2) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency

Communications (URLLC), and massive Machine-Type Communications (mMTC), there has been ongoing standardization regarding beamforming and massive multiple-input and multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for conditional moving so as to eliminate uncertainty in signals provided during lower layer-based inter-cell moving performed by a UE.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station on a serving cell, configuration information on a conditional lower layers triggered mobility (CLTM), performing a measurement on cells, based on the configuration information, and performing a handover to one cell of the cells, based on a result of the measurement.

In accordance with an aspect of the disclosure, a method performed by a distributed unit (DU) on a serving cell in a wireless communication system is provided. The method includes transmitting, to a central unit (CU), condition information on a conditional lower layers triggered mobility (CLTM), and transmitting, to a user equipment (UE), configuration information including the condition information.

In accordance with an aspect of the disclosure, a user equipment (UE) in a wireless communication system is provided. The UE includes a transceiver, and a controller coupled with the transceiver and configured to receive, from a base station (BS) on a serving cell, configuration information on a conditional lower layers triggered mobility (CLTM), perform a measurement on cells, based on the configuration information, and perform a handover to one cell of the cells, based on a result of the measurement.

In accordance with an aspect of the disclosure, a base station (BS) in a wireless communication system is provided. The BS includes a transceiver, and a controller coupled with the transceiver and configured to transmit, to a central unit (CU), condition information on a conditional lower layers triggered mobility (CLTM), and transmit, to a user equipment (UE), configuration information including the condition information.

According to an embodiment of the disclosure, in case that a specific condition is satisfied when performing lower layer measurement, a UE may perform inter-cell moving even when a signal received from a base station is unstable as the UE moves on its own.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a wireless communication system (e.g., long term evolution (LTE) system) according to an embodiment of the disclosure;

FIG. 2 illustrates a radio protocol structure of a wireless communication system according to an embodiment of the disclosure;

FIG. 3 illustrates a structure of a wireless mobile communication system according to an embodiment of the disclosure;

FIG. 4 illustrates a radio protocol structure of a wireless mobile communication system according to an embodiment of the disclosure;

FIG. 5 illustrates a structure of a UE according to an embodiment of the disclosure;

FIG. 6 illustrates a structure of a base station according to an embodiment of the disclosure;

FIG. 7 illustrates an operation of a UE based on cell measurement according to an embodiment of the disclosure;

FIG. 8 illustrates an operating method of a UE according to an embodiment of the disclosure;

FIG. 9 illustrates an operating method of a network according to an embodiment of the disclosure;

FIG. 10 illustrates an operating method of a UE and a base station according to an embodiment of the disclosure; and

FIG. 11 illustrates an example of applying conditional lower layer triggered mobility (LTM) to a network energy saving (NES) mode according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-Advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

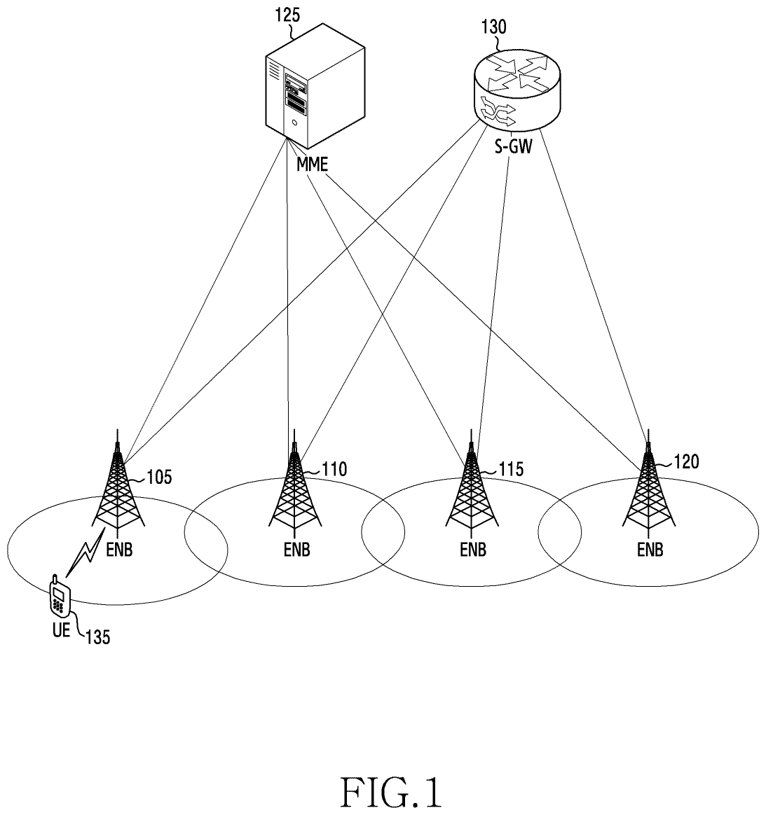

FIG. 1 illustrates a structure of a wireless communication system (e.g., LTE system) according to an embodiment of the disclosure.

Referring to FIG. 1, a radio access network of an LTE system may include next-generation base stations (evolved node Bs, hereinafter ENBs, node Bs, or base stations) 105, 110, 115, and 120, a mobility management entity (MME) 125, and a serving gateway (S-GW) 130. A user equipment (hereinafter UE or terminal) 135 may access an external network through the ENBs 105 to 120 and the S-GW 130.

In FIG. 1, the ENBs 105 to 120 may correspond to a conventional node B in a UMTS system. The ENBs may be connected to the UE 135 through a radio channel, and perform more complicated roles than the conventional node Bs. In the LTE system, since all user traffic including real-time services, such as voice over IP (VoIP) via the Internet protocol, may be serviced through a shared channel. Thus, a device that collects state information, such as buffer states, available transmit power states, and channel states of UEs, and performs scheduling accordingly is required, and the ENBs 105 to 120 may serve as the device. In general, one ENB may control multiple cells. For example, in order to implement a transfer rate of 100 Mbps, the LTE system may use orthogonal frequency division multiplexing (OFDM) as a radio access technology in a bandwidth of, for example, 20 MHz. Furthermore, the LTE system may employ an adaptive modulation & coding (AMC) scheme for determining a modulation scheme and a channel coding rate according to a channel state of a UE. The S-GW 130 is a device that provides a data bearer, and may generate or remove a data bearer under the control of the MME 125. The MME is a device responsible for various control functions as well as a mobility management function for a UE, and may be connected to multiple base stations.

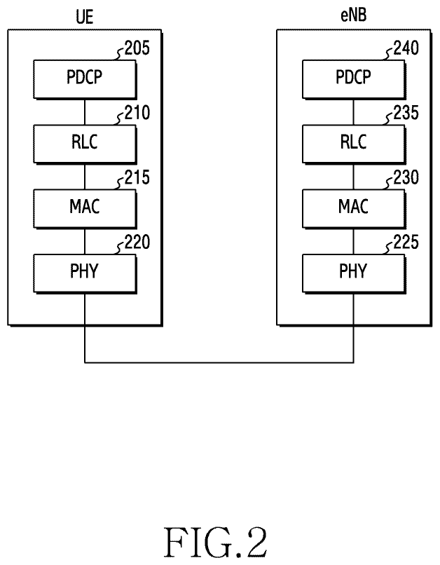

FIG. 2 illustrates a radio protocol structure of a wireless communication system (e.g., LTE system) according to an embodiment of the disclosure.

Referring to FIG. 2, a radio protocol of an LTE system may include a packet data convergence protocol (PDCP) 205 or 240, a radio link control (RLC) 210 or 235, and a medium access control (MAC) 215 or 230 on each of UE and ENB sides. The PDCP may serve to perform operations such as IP header compression/reconstruction. The main functions of the PDCP may be summarized as follows.
Header compression and decompression: robust header compression (ROHC) only
Transfer of user data
In-sequence delivery of upper layer protocol data units (PDUs) at PDCP re-establishment procedure for RLC acknowledged mode (AM)
For split bearers in DC (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (RLC) 210 or 235 may reconfigure a PDCP protocol data unit (PDU) into an appropriate size to perform an ARQ operation. The main functions of the RLC may be summarized as follows.
Transfer of upper layer PDUs
Error Correction through automatic repeat request (ARQ) (only for AM data transfer)
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 215 or 230 may be connected to several RLC layer devices configured in a single terminal, and multiplex RLC PDUs into a MAC PDU and demultiplex a MAC PDU into RLC PDUs. The main functions of the MAC are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid ARQ (HARQ)
Priority handling between logical channels of one UE
Priority handling between UEs by means of dynamic scheduling
Multimedia broadcast multicast service (MBMS) service identification
Transport format selection
Padding

A physical layer 220 or 225 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

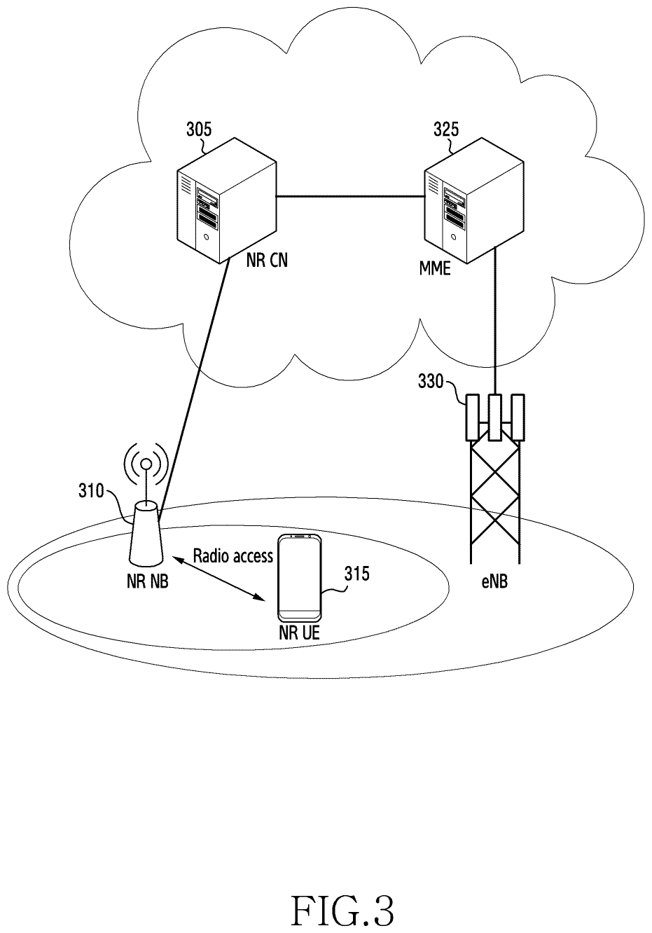

FIG. 3 illustrates a structure of a wireless mobile communication system according to an embodiment of the disclosure.

Referring to FIG. 3, a radio access network of a wireless mobile communication system (hereinafter NR or 5G) may include a new radio node B (hereinafter NR gNB or NR base station) 310, and a new radio core network (NR CN) 305. A new radio user equipment (NR UE or NR terminal) 315 may access an external network via the NR gNB 310 and the NR CN 305.

In FIG. 3, the NR gNB 310 may correspond to an evolved node B (eNB) of a conventional LTE system. The NR gNB may be connected to the NR UE 315 through a radio channel and provide outstanding services as compared to a conventional node B. In the next-generation mobile communication system, since all user traffic may be serviced through a shared channel. Thus, a device that collects state information, such as buffer states, available transmit power states, and channel states of UEs, and performs scheduling accordingly is required, and the NR gNB 310 may serve as the device. In general, one NR gNB may control multiple cells. In order to implement ultrahigh-speed data transfer beyond the current LTE, the next-generation mobile communication system may provide a wider bandwidth than the existing maximum bandwidth. in addition, the next-generation mobile communication system may employ an orthogonal frequency division multiplexing (OFDM) as a radio access technology, and may additionally integrate a beamforming technology therewith. Furthermore, the next-generation mobile communication system may employ an adaptive modulation & coding (AMC) scheme for determining a modulation scheme and a channel coding rate according to a channel state of a UE. The NR CN 305 may perform functions such as mobility support, bearer configuration, and quality of service (QOS) configuration. The NR CN is a device responsible for various control functions as well as a mobility management function for a UE, and may be connected to multiple base stations. In addition, the next-generation mobile communication system may interwork with the existing LTE system, and the NR CN may be connected to an MME 325 via a network interface. The MME may be connected to an eNB 330 that is an existing base station.

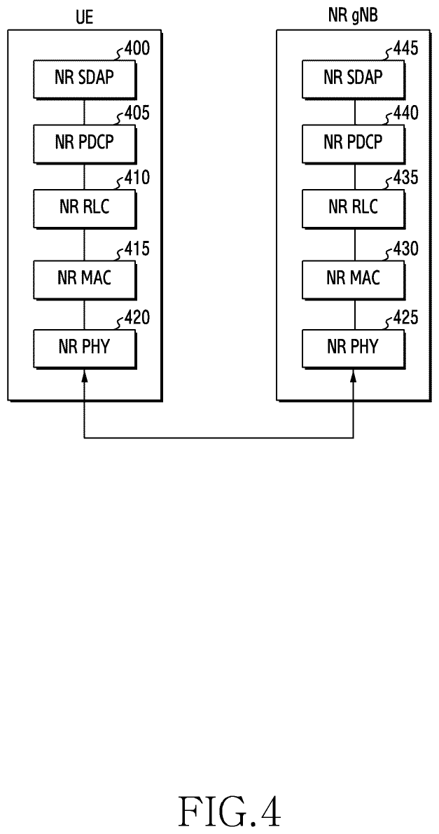

FIG. 4 illustrates a radio protocol structure of a wireless mobile communication system according to an embodiment of the disclosure.

Referring to FIG. 4, a radio protocol of a wireless mobile communication system may include an NR service data adaptation protocol (SDAP) 400 or 445, an NR PDCP 405 or 440, an NR RLC 410 or 435, an NR MAC 415 or 430, and an NR physical (PHY) 420 or 425 on each of UE and NR base station sides.

The main functions of the NR SDAP 400 or 445 may include some of functions below.
Transfer of user plane data and mapping between a QoS flow and a data radio bearer (DRB) for both DL and UL
Marking QoS flow identifier (ID) in both DL and UL packets
Reflective QoS flow to DRB mapping for the UL SDAP PDUs

With regard to the SDAP layer device, whether to use the header of the SDAP layer device or whether to use functions of the SDAP layer device may be configured for the UE through a radio resource control (RRC) message according to PDCP layer devices or according to bearers or according to logical channels. If an SDAP header is configured, the non-access stratum (NAS) quality of service (QOS) reflection configuration 1-bit indicator (NASreflective QoS) of the SDAP header and the access stratum (AS) QoS reflection configuration1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 405 or 440 may include some of functions below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The above-mentioned reordering of the NR PDCP device may refer to a function of reordering PDCP PDU received from a lower layer in an order based on PDCP sequence numbers (SNs). The reordering of the NR PDCP device may include a function of transferring data to an upper layer according to a rearranged order, may include a function of directly transferring data without considering order, may include a function of rearranging order to record lost PDCP PDUs, may include a function of reporting the state of lost PDCP PDUs to a transmission side, and may include a function of requesting retransmission of lost PDCP PDUs.

The main functions of the NR RLC 410 or 435 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device refers to a function of delivering RLC SDUs, received from the lower layer, to the upper layer in sequence. If one original RLC SDU is divided into several RLC SDUs and the RLC SDUs are received, the in-sequence delivery function of the NR RLC device may include a function of reassembling the several RLC SDUs and transferring the reassembled RLC SDUs.

The in-sequence delivery function of the NR RLC device may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, and may include a function of requesting retransmission of lost RLC PDUs.

The in-sequence delivery of the NR RLC device may refer to a function of, if there is a lost RLC PDU, delivering only RLC SDUs before the lost RLC PDU to the upper layer in sequence.

The in-sequence delivery of the NR RLC device may include a function of, although there is a lost RLC SDU, if a predetermined timer has expired, sequentially transferring, to a higher layer, all the RLC SDUs received before the timer is started.

The in-sequence delivery of the NR RLC device may include a function of, although there is a lost RLC SDU, if a predetermined timer has expired, sequentially transferring all the RLC SDUs received up to now, to the upper layer.

The NR RLC device may process RLC PDUs in a reception sequence, regardless of a sequence based on sequence numbers (out-of-sequence delivery). and then deliver the processed RLC PDUs to the NR PDCP device.

If receiving segments, the NR RLC device may receive segments stored in a buffer or to be received in the future, reconfigure the segments into one whole RLC PDU, process the RLC PDU, and then deliver the processed RLC PDU to the NR PDCP device.

The NR RLC layer may not include the concatenation function, which may be performed in the NR MAC layer or replaced with a multiplexing function of the NR MAC layer.

The above-mentioned out-of-sequence delivery of the NR RLC device may refer to a function of instantly delivering RLC SDUs received from the lower layer to the upper layer regardless of the order. The out-sequence delivery of the NR RLC device may include a function of, if one original RLC SDU is segmented into multiple RLC SDUs and the segmented RLC SDUs are received, reassembling the RLC SDUs and delivering the reassembled RLC SDUs. The out-of-sequence delivery function of the NR RLC device may include a function of storing an RLC sequence number (SN) or a PDCP sequence number (SN) of received RLC PDUs and arranging order to record lost RLC PDUs.

The NR MAC 415 or 430 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layer 420 or 425 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

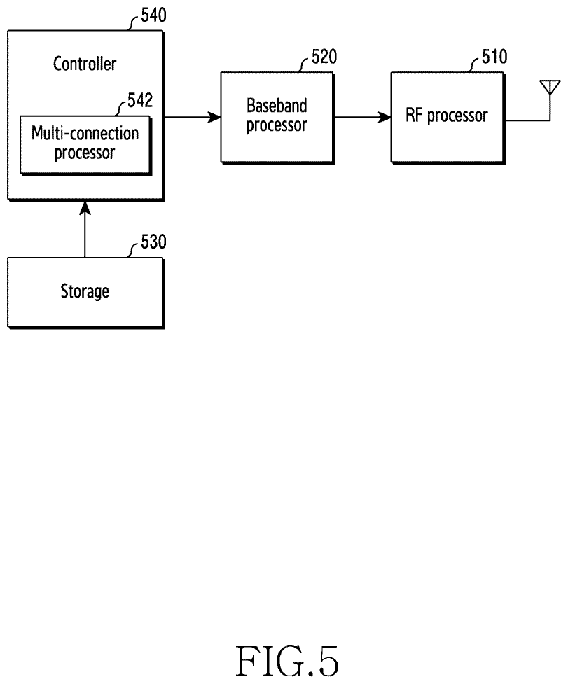

FIG. 5 illustrates a structure of a UE according to an embodiment of the disclosure.

Referring to FIG. 5, the UE may include a radio frequency (RF) processor 510, a baseband processor 520, a storage 530, and a controller 540.

The RF processor 510 may perform a function for transmitting and receiving a signal via a wireless channel, such as band conversion and amplification of the signal. That is, the RF processor 510 may up-convert a baseband signal provided from the baseband processor 520 to an RF band signal, may transmit the same through an antenna, and may down-convert an RF band signal received through the antenna to a baseband signal. For example, the RF processor 510 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. In addition, the RF processor 510 may include multiple RF chains. Furthermore, the RF processor 510 may perform beamforming. For the beamforming, the RF processor 510 may adjust the phase and magnitude of each of signals transmitted and received through multiple antennas or antenna elements. In addition, the RF processor may perform MIMO, and may receive multiple layers when performing a MIMO operation.

The baseband processor 520 may perform functions of conversion between baseband signals and bitstrings according to the system's physical layer specifications. For example, during data transmission, the baseband processor 520 may encode and modulate a transmitted bitstring to generate complex symbols. In addition, during data reception, the baseband processor 520 may demodulate and decode a baseband signal provided from the RF processor 510 to restore a received bitstring. For example, when following the orthogonal frequency division multiplexing (OFDM) scheme, during data transmission, the baseband processor 520 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 520 may split a baseband signal provided from the RF processor 510 at the OFDM symbol level, may restore signals mapped to subcarriers through a fast Fourier transform (FFT) operation, and may restore a received bitstring through demodulation and decoding.

The baseband processor 520 and the RF processor 510 may transmit and receive signals as described above. Therefore, the baseband processor 520 and the RF processor 510 may be referred to as a transmitter, a receiver, a transceiver, or a communication unit. Furthermore, at least one of the baseband processor 520 and the RF processor 510 may include multiple communication modules to support multiple different radio access technologies. In addition, at least one of the baseband processor 520 and the RF processor 510 may include different communication modules to process signals in different frequency bands. For example, the different radio access technologies may include a wireless local area network (LAN) (e.g., IEEE 802.11), a cellular network (e.g., LTE), and the like. In addition, the different frequency bands may include super high frequency (SHF) (e.g., 2 NRHz) bands and millimeter wave (mmWave) (e.g., 60 GH−) bands.

The storage 530 stores data such as basic programs, application programs, and configuration information for operations of the UE. In particular, the storage 530 may store information related to the second access node, which performs wireless communication using the second wireless access technology. In addition, the storage 530 provides the stored data at the request of the controller 540.

The controller 540 controls the overall operation of the UE. For example, the controller 540 may transmit/receive signals through the baseband processor 520 and the RF processor 510. In addition, the controller 540 records data in the storage 530 and reads the data from the storage 530. To this end, the controller 540 may include at least one processor. For example, the controller 540 may include a communication processor (CP) configured to perform control for communication, an application processor (AP) configured to control upper layers such as application programs, and a multi-connection processor 542.

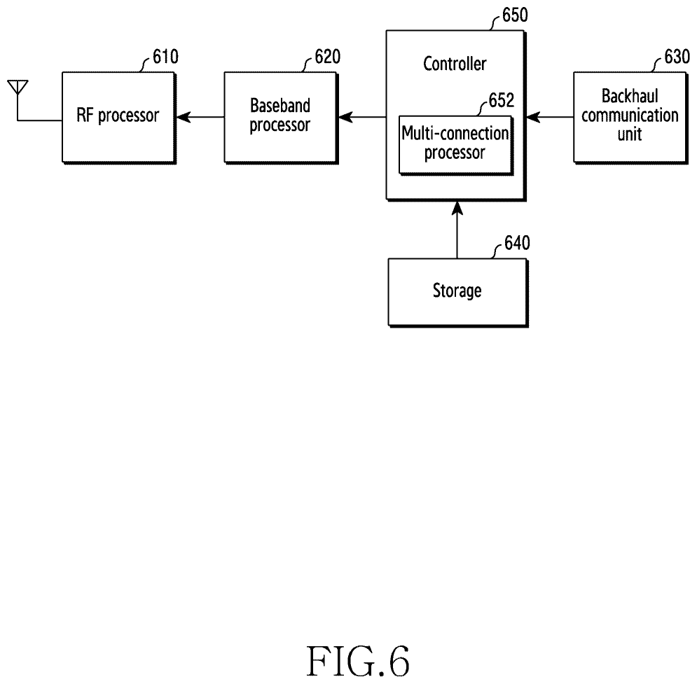

FIG. 6 illustrates a structure of a base station according to an embodiment of the disclosure.

Referring to FIG. 6, the base station may include an RF processor 610, a baseband processor 620, a backhaul communication unit 630, a storage 640, and a controller 650.

The RF processor 610 may perform a function for transmitting and receiving a signal via a wireless channel, such as band conversion and amplification of the signal. That is, the RF processor 610 may up-convert a baseband signal provided from the baseband processor 620 to an RF band signal, may transmit the same through an antenna, and may down-convert an RF band signal received through the antenna to a baseband signal. For example, the RF processor 610 may include a transmission filter, a reception filter, an amplifier, a mixer, an oscillator, a DAC, and an ADC. Although only one antenna is illustrated in the drawing, the first access node may include multiple antennas. In addition, the RF processor 610 may include multiple RF chains. Furthermore, the RF processor 610 may perform beamforming. For the beamforming, the RF processor 610 may adjust the phase and magnitude of each of signals transmitted and received through multiple antennas or antenna elements. The RF processor may transmit one or more layers to perform a downward MIMO operation.

The baseband processor 620 may perform functions of conversion between baseband signals and bitstrings according to the physical layer specifications of a first radio access technology. For example, during data transmission, the baseband processor 620 may encode and modulate a transmitted bitstring to generate complex symbols. In addition, during data reception, the baseband processor 620 may demodulate and decode a baseband signal provided from the RF processor 610 to restore a received bitstring. For example, when following the OFDM scheme, during data transmission, the baseband processor 620 may encode and modulate a transmitted bitstring to generate complex symbols, may map the complex symbols to subcarriers, and may configure OFDM symbols through an IFFT operation and CP insertion. In addition, during data reception, the baseband processor 620 may split a baseband signal provided from the RF processor 610 at the OFDM symbol level, may restore signals mapped to subcarriers through FFT operation, and may restore a received bitstring through demodulation and decoding. The baseband processor 620 and the RF processor 610 may transmit and receive signals as described above. Therefore, the baseband processor 620 and the RF processor 610 may be referred to as a transmitter, a receiver, a transceiver, a communication unit, or a wireless communication unit.

The backhaul communication unit 630 provides an interface for performing communication with other nodes in the network. That is, the backhaul communication unit 630 may convert bitstrings transmitted from the main base station to other nodes (for example, auxiliary base station, core network) to physical signals, and may convert physical signals received from the other nodes to bitstrings.

The storage 640 stores data such as basic programs, application programs, and configuration information for operations of the base station. In particular, the storage 640 may store information on bearers allocated to the connected UE, measurement results reported from the connected UE, and the like. In addition, the storage 640 may store information serving as a criterion for determining whether to provide or stop multiple connections to the UE. In addition, the storage 640 provides the stored data at the request of the controller 650.

The controller 650 controls the overall operation of the base station. For example, the controller 650 may transmit/receive signals through the baseband processor 620 and the RF processor 610 or through the backhaul communication unit 630. In addition, the controller 650 records data in the storage 640 and reads the data from the storage 640. To this end, the controller 650 may include at least one processor (e.g., a multi-connection processor 652). The Lower Layer Triggered Mobility (LTM) technology, as defined in the 3rd generation partnership project (3GPP) Release 18 standard specifications, enables, when the network explicitly transmits a cell switch command, a UE to perform a cell switch to a corresponding target cell. However, in case of a Uu interface transferring a cell switch command, depending on a frequency band in Uu used, reliability may not be guaranteed. Since operations of directing the movement of a UE are considered the last resort for controlling the UE in the serving cell, a method to ensure reliability is required.

An apparatus and a method according to an embodiments of the disclosure correspond to an apparatus and a method that may, even if a network does not transmit a cell switch command to a UE to perform LTM, perform LTM to a target cell associated with the condition when a preconfigured condition is satisfied. To this end, a specific condition may be associated with a target cell configuration on a specific candidate target cell and configured for the UE.

A serving gNB may transmit the following configurations to the UE via a serving spcell. The following configurations may be delivered to the UE through a RRCReconfiguration message.
Conditional LTM indicator: A UE may recognize that the information associated with this indicator is configuration information for conditional LTM.
reference configuration to be applied to a configuration of each candidate target spcell
per Candidate target spcell configuration

C-LTM (conditional LTM) candidate configuration ID: When multiple C-LTM configurations are provided, an ID is required for add/mod/release of a corresponding per cell configuration information. It is possible to command to add a new candidate configuration, update or delete an existing configuration by using the ID.

Ltm candidate PCI: PCI and frequency information NR ARFCN of a corresponding target cell

SSB config: Index and time/frequency location information of an SSB being transmitted by a corresponding target cell, beam information being transmitted, an SSB cycle value, and an offset value indicating a start of a cycle

candidate configuration: This configures a cell that a UE needs to use in a corresponding target cell, which may include an RRCReconfiguration message.

complete of not indicator: This may indicate an indicator indicating whether a candidate configuration is complete or not.

early UL sync config: This may indicate configuration information of early RA that a UE performs to acquire TA information in a candidate cell.

early UL sync config SUL: This may indicate configuration information of early RA in supplementary UL frequency, that a UE performs to acquire TA information in a candidate cell.

LTM-TCI-Info: This may indicate a beam of candidate cells and an SSB index associated with the corresponding beam. If this information exists in a specific cell, the UE may perform pre-synchronization, even for cells that do not belong to the ltm-CSI-ResourceConfig, to eliminate the latency of performing DL synchronization when performing LTM later.

Condition information used to trigger LTM to a specific target cell
Hereinafter, condition information will be described.
The condition may include comparison a spcell with another cell. For example, a comparison of a pcell with another cell (hereafter, it may be considered a non-serving cell or neighbor cell) in a master cell group (MCG) and a comparison of pscell with another cell in a secondary cell group (SCG) may be defined as an event.

The condition information may include a combination of a measurement target and a specific condition.

>The measured target (C LTM vector) may always include “a specific target cell.”

Embodiment 1. LTM-CSI-ResourceConfig ID and CSI measurement configuration of a current spcell: LTM-CSI-ResourceConfig ID. That is, a vector of specific SSB indices of specific LTM candidate cells provided by the serving cell of a current UE may only indicate candidate cells. That is, the current cell may not be included in this target.

In this case, CSI measurement/reporting based on CSI-RS needs to be configured and measured in the current serving cell. The difference compared to traditional conditional handover (CHO) is that in the case of L3 radio resource management (RRM), the serving cell measurement may always be performed without additional configuration.

Embodiment 2. LTM-CSI-ResourceConfig ID+serving cell (current spcell): In embodiment 1, in a state where specific SSB indices of LTM candidate cells are provided, serving cell-related information may be additionally indicated or associated with the LTM-CSI-ResourceConfig ID in a standardized manner. Here, the information serving cell-related information may include at least one of the following.

An indicator indicating a serving cell index or spcell

CSI-RS resource config in a serving cell for conditional LTM, or at least one of CSI-resourceConfig IDs that are preconfigured in the serving cell, or a CSI-reportConfig ID that is preconfigured in the serving cell (the CSI resource that the ID indicates may be referenced.).

Embodiment 3. If an event-triggered L1 meas/report has already been introduced, a resource ID corresponding to the event-triggered CSI-RS measurement target may be indicated.

In this case, the measurement target may include Information of specific multi-cells (PCI and/or AFRCN) and measurement target RSs (a part of the SSB index and/or a list or set of CSI-RS resources configured in the cells, and/or a CSI-RS set to be measured for event triggered purposes in a current serving cell.

In this case, as a specific condition, in event triggered L1 meas/report, a report configuration may have an accompanying report configuration indicating conditional LTM type or event triggered report type. An embodiment thereof will be described below for alternatives related to the condition.

Embodiment 4. PCI and/or AFRCN of a “specific tart get cell” and configuration information of an RS (e.g., SSB index and/or CSI-RS configuration on that cell) corresponding to a measurement target may be transmitted to a UE for conditional LTM without separate vector information. That is, measurement for another cell may not be necessary.

Feature for each embodiment: In embodiments 1, 2, and 3, multiple candidate cells may be included in the measurement target in addition to the “specific target cell”, and thus one of the multiple candidate cells may be considered as the “specific target cell” and re-used. That is, one measurement vector may be re-used as condition information of multiple “specific target cells.” In the case of embodiment 4, measurement may be performed with respect to one cell, thus a different measurement target may be required for each “specific target cell.”

When a measurement target is provided, a UE may perform RS measurement for CSI indicated to the target. In this case, separate factors such as the following may be required, and the serving cell may configure the values to the UE (by including in the measurement target or condition configuration) when configuring the conditional LTM.

Time average value of a measurement sample when measuring a measurement target when averaging a specific number of samples, the network may configure the number of values to the UE.

A time window value for a time average of a measurement sample when measuring a measurement target. Whatever number of samples are acquired over the time of this value, the average value or linear combination of those samples may be made, and that value may be used to determine the condition. A time window value or values of a and b in a*(1t(n))+b*t(n+1). (For reference, t(n) represents a final linear combination result of RS measurement values of the measurement target until time n, and t(n+1) represents the linear combination value up to time n+1, which may represent a result of a linear combination of previous result values.

Specific condition: The condition associated with the measurement target needs to be determined based on the value measured with the measurement target and may be required to perform LTM to a specific target cell associated with the measurement target and condition.

Embodiment 5. Separate condition information may be configured to a UE. In this case, the condition information may include a cell (reception signal) strength-based condition and/or a beam (reception signal) strength-based condition.

In case that only the cell strength condition is configured to the UE, when the condition is satisfied, the UE may perform LTM to a specific cell associated with the condition.

In case that only the beam-based condition is configured, when the condition is satisfied, the UE may perform LTM to a specific cell associated with the condition.

In case that both the beam and cell-based conditions are configured, when one of the conditions is satisfied, the UE may perform LTM to a specific cell associated with the condition.

In case that both the beam and cell-based conditions are configured, when with respect to a candidate cell for which a cell-based condition is satisfied, the beam-based condition associated with the cell is satisfied, that is both the cell-based condition and the beam based-condition are satisfied, the UE may LTM to the candidate cell associated with the conditions.

The condition itself may use a combination of beam and cell strengths.

In this case, when the condition is satisfied, the UE may perform LTM to a specific cell associated with the condition.

Cell strength-based conditions may include following conditions.

A case where a reception signal strength of a serving cell is greater than or equal to or less than or equal to a specific threshold value (case A)

A case where a reception signal strength of a specific serving cell (a specific candidate cell associated with CLTM) is greater than or equal to or less than or equal to a specific threshold value (case B)

A case where the reception signal strength of a serving cell is greater or less than a specific non-serving cell (a specific candidate cell associated with CLTM) included in the measurement target by a difference of more than an offset value (case C)

An event type may be introduced with respect to each case. In addition, for each event type, a required threshold value and/or offset value may be configured for the UE together.

Beam-based conditions (in the following, the meaning of candidate beam may refer to a beam that is indicated by the aforementioned measurement target.)

(In case that only the beam condition is used) A case where a signal strength of a candidate beam from among CLTM candidate cells included in the measurement target is greater than or equal to or less than or equal to a threshold

(In case that only the beam condition is used) A case where a signal strength of a candidate beam from among CLTM candidate cells included in the measurement target is greater than or less than a beam signal strength of a current serving cell by a difference greater than or equal to a offset value

A case of a combination of the cell-based condition and the beam-based condition (this case corresponds to a condition for a specific target cell and the measurement target may be indicated together with the cell-based condition and the beam-based condition.)

In case that the cell-based condition is satisfied (e.g., in case A, a specific non-serving cell in the measurement target is greater than or equal to or less than or equal to a threshold value, or in case B, a serving cell is greater than a specific non-serving cell by a difference of more than or equal to an offset, or less than a specific non-serving cell by a difference of more than or equal to an offset) and a case where, for a specific non-serving cell, a signal strength of a beam of the corresponding non-serving cell included in the measurement target is greater than or equal to or less than or equal to a threshold value

In case that the cell-based condition is satisfied (e.g., in case A, a specific non-serving cell in the measurement target is greater than or equal to or less than or equal to a threshold value, or in case B, a serving cell is greater than a specific non-serving cell by a difference of more than or equal to an offset, or less than a specific non-serving cell by a difference of more than or equal to an offset) and a case where, for a specific non-serving cell, a signal strength of a beam of the corresponding non-serving cell included in the measurement target is greater than or less than a beam signal strength value of a serving cell by a difference greater than or equal to a reference offset

(Unlike the case where the beam is determined independently regardless of the cell) a case where the cell-based condition is satisfied, it is determined to perform LTM to the corresponding specific target cell, and there is a beam “among the beams in that specific target cell” that satisfies the beam-based condition (e.g., there is a beam having a beam strength equal to or greater than a specific threshold value among beams of the corresponding specific cell)

In this case, a cell may be determined based on the cell-based condition and a beam to be used in the corresponding cell may be determined based on the beam condition.

Cell/Beam based combination conditions

a case where a signal strength of a serving cell is greater than or less than a signal strength of any beam of any non-serving cell by a difference greater than or equal to an offset

a case where a specific beam of a serving cell is greater than or less than a signal strength of any non-serving cell by a difference greater than or equal to an offset

Embodiment 6. Information for a specific condition may be defined as a report type of separated LI measurement and report.

In case that Event triggered LI meas/report is configured, a report Type for conditional LTM conditions may be configured as a subcategory of the reportType of the event triggered report. Alternatively, report Type may be configured for conditional LTM to reportType of CSI-reportConfig not as a subcategory.

Even in case that indicated as report type, according to each condition type (i.e., variations of cell-based conditions, variations of beam-based conditions, and variations of cell and beam combination conditions) in embodiment 5, parameters required to configure the condition, i.e., parameter information such as what the condition is, an offset value required for the condition, a hysteresis value, and the like, may be associated with the report type and indicated to the UE.

In case that the condition is indicated for report type purposes, the UE, when the condition is satisfied, may perform conditional LTM to a specific target cell associated with the satisfied condition without reporting the measurement result for the measurement target.

The measurement target is indicated by CSI-ResourceConfig ID in CSI-reportconfig, and the specific condition may be configured by report type associated with the conditional LTM in reportType in CSI-ReportConfig, and an ID in CSI-reportConfig configured by CSI-ResourceConfig ID and instance of reportType may concurrently indicate the target and condition.

When receiving conditions, a UE may receive both cell-based and beam-based conditions at the same time. In this case, Conditional LTM may be triggered based on cell-based conditions, and a beam that satisfies the beam condition may be further selected from the triggered target cell and used by the UE to perform LTM. Beams may be used for the following purposes.

Based on the corresponding beam, a RACH procedure may be performed for each Uplink/Downlink beam. For example, the corresponding beam may be used for transmitting a random access (RA) preamble and/or receiving a random-access response (RAR).

If RACH-less LTM is included in the candidate configuration, or indicated from the network, the corresponding beam may be used for physical downlink control channel (PDCCH) monitoring purposes to acquire a dynamic grant after traveling to the target cell.

Alternatively, if RACH-less LTM is indicated, the first UL data transmission may be performed with the beam after traveling to the target cell.

If the CLTM does not include a separate beam condition and RACH-less LTM is indicated, the beam reception signal strength threshold value through the RRC configuration may be separately transferred to the UE, independent of the condition. The UE may use one of the beams having a signal strength greater than or equal to a threshold value at the target cell as a beam for transmitting UL data transmission or for PDCCH monitoring to acquire dynamic grants.

Alternatively, the beam may be indicated to the UE prior to the conditional LTM through an existing TCI state activation MAC CE.

The conditions according to an embodiments of the disclosure may be a combination of one of embodiments 1 to 4 for the measurement target and one of embodiments 5 to 6 for a specific condition.

The UE may receive the measurement target and the specific condition in the RRCReconfiguration together with other configuration information of conditional LTM. The UE, in case that conditional LTM (CLTM) or reportType corresponding thereto is configured in reportType of CSI-reportConfig, which is associated with the specific condition, may start measurement of CLTM measurement target associated thereto. Alternatively, the UE may perform the measurement immediately after receiving the measurement target or the measurement reportType indicator, or when the measurement is activated by a separate DL MAC CE or DCI. To this end, an indicator that dictates immediate measurement or measurement based on dynamic activation may additionally be associated with the reportType associated with the measurement target or condition.

The UE, when identifying measurement target/condition information including the indicator indicating that dynamic activation is possible after RRCReconfiguration is received, may not perform measurements immediately after receiving the message, but when the network indicates activation of measurement, may start the measurement and perform a condition evaluation.

The UE, in case that there is no indicator that dynamic activation is possible after RRCReconfiguration is received, or if the measurement target/condition information including an indicator to measure immediately is identified, may start measuring immediately after receiving the message and perform condition evaluation.

In case that the resources of the RS of the measurement target for CLTM are relatively sparsely radiated, or there is a time delay from each distributed unit (DU) to the transmission of the reference signal (RS), or the like, dynamic activation may be determined by the serving DU and indicated to the UE.

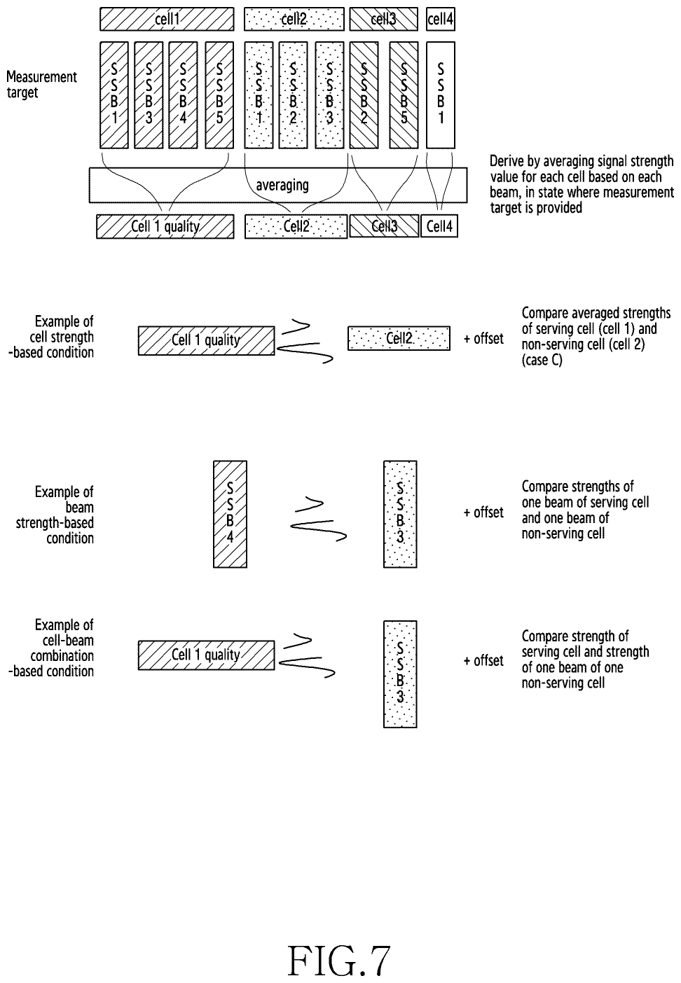

FIG. 7 illustrates an operation of a UE based on cell measurement according to an embodiment of the disclosure.

Referring to FIG. 7, a UE may perform measurement with respect to multiple cells including cell 1, cell 2, and the like. Specifically, the UE may perform measurement with respect to an SSB of multiple cells and measure a quality of each cell according to a result of the measurement. Here, the quality of the cell may be measured by averaging measurements for multiple SSBs.

In case that the UE determines whether the condition is satisfied, based on the cell strength, the UE may compare averaged strength values of the serving cell (e.g., cell 1) and the non-serving cell (e.g., cell 2). Here, the UE may determine whether the strength of the serving cell and the strength of the non-serving cell differ by more than or equal to the offset value so as to determine whether the condition is satisfied.

In case that the UE determines whether the condition is satisfied, based on the beam strength, the UE may compare a strength with respect to a beam (e.g., SSB 4 of cell 1) of the serving cell and a strength with respect to a beam (e.g., SSB 3 of cell 2) of the non-serving cell. Here, the UE may determine whether the signal strength with respect to the beam of the serving cell and the signal strength with respect to the beam of the non-serving cell differ by more than or equal to the offset value so as to determine whether the condition is satisfied.

In case that the UE determines whether the condition combined based on the strengths of the cell/beam is satisfied, the UE may compare the strength of the serving cell and the strength of the non-serving cell. Here, the UE may determine whether the signal strength of the serving cell and the signal strength with respect to the beam of the non-serving cell differ by more than or equal to the offset value so as to determine whether the condition is satisfied.

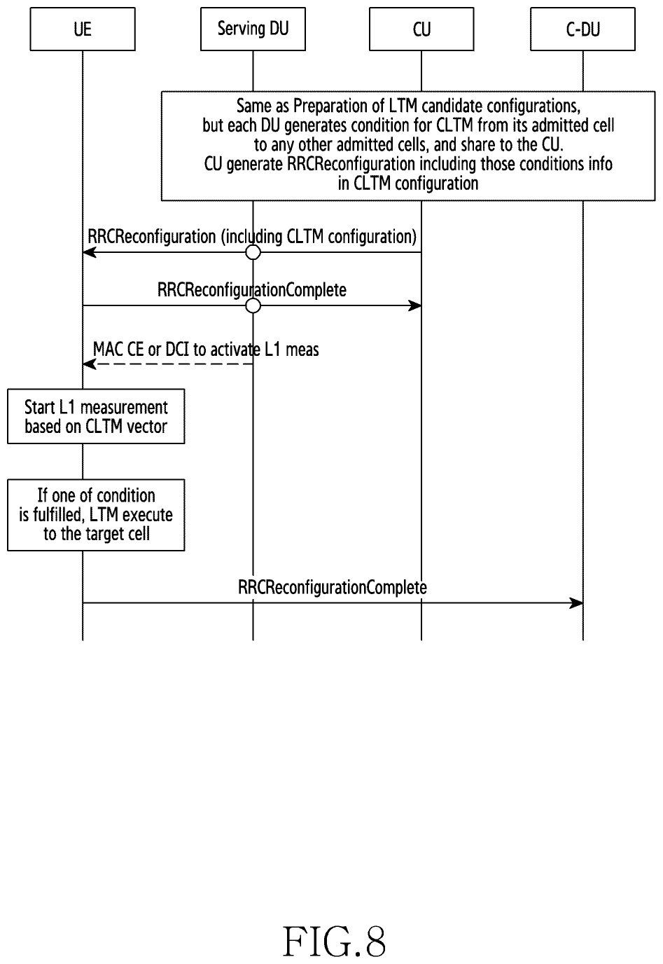

FIG. 8 illustrates an operating method of a UE according to an embodiment of the disclosure.

The CU, the serving DU, and the candidate DU (C-DU) may configure a conditional LTM candidate configuration. In this procedure, each serving DU may generate the condition information of the CLTM that moves to another candidate cell, using a cell of the serving DU as the source cell.

The CLTM configuration information generated thereafter may be transferred to the UE as follows.
Spcell of the serving DU may transfer the RRCReconfiguration message including the CLTM configuration information to the UE.
The UE may receive the message and perform following operations.

1. Receiving the CLTM configuration (receiving RRCReconfiguration)

Identifying that there is the CLTM configuration, storing the CLTM configuration, and immediately starting measurement based on the measurement target associated with each candidate cell for L1 measurement (Optionally, if there is an indicator in the REPORTTYPE for CLTM that indicates that dynamic activation of the measurement is possible, the measurement may be performed when the activation signal of the measurement for CLTM is received through DCI or DL MAC CE on the network after the RRCReconfiguration message.)

The UE may start evaluating the provided condition as soon as starting the measurement.

2. When the condition is satisfied, applying a target configuration of a CLTM candidate cell associated with the corresponding condition (performing HO)

3. After performing RACH (RA based), transferring a complete message to the target cell or performing initial UL data transmission (RACH-less)

4. End

The network side may perform the following operations.
CLTM preparation procedure in the network (assuming intra-CU)

Each DU in central unit (CU) generates the condition for CLTM for the case from this DU's admitted cell to any other cells admitted for LTM. Each DU in CU may generate the condition for CLTM for the case from this DU's admitted cell (LTM source cell) to another cell (LTM candidate target cell) admitted for LTM.

In detail, once each DU get to know the all the other admitted cells, then condition from one of its admitted cells to all the other admitted cell should be generated by this DU. And the condition info (the measurement target or the specific condition, or a combination of the measurement target and the specific condition) should be shared to the CU. In detail, once each DU gets to know the admitted cells from the other DUs (or with respect to the admitted cell allowed to be known), this DU may generate a condition from one of cells admitted to the DU (LTM source cell) to a cell (LTM candidate target cell) admitted from other DUs. In addition, the condition information (the measurement target or the specific condition, or a combination of the measurement target and the specific condition) may be shared to the CU.

CU include those condition info and the associated CLTM target cell info into the CLTM configuration in RRCReconfiguration. The CU may include “specific condition information and/or CLTM measurement target information associated therewith” with respect to such target candidate cell into CLTM configuration of RRCRecfiguration.

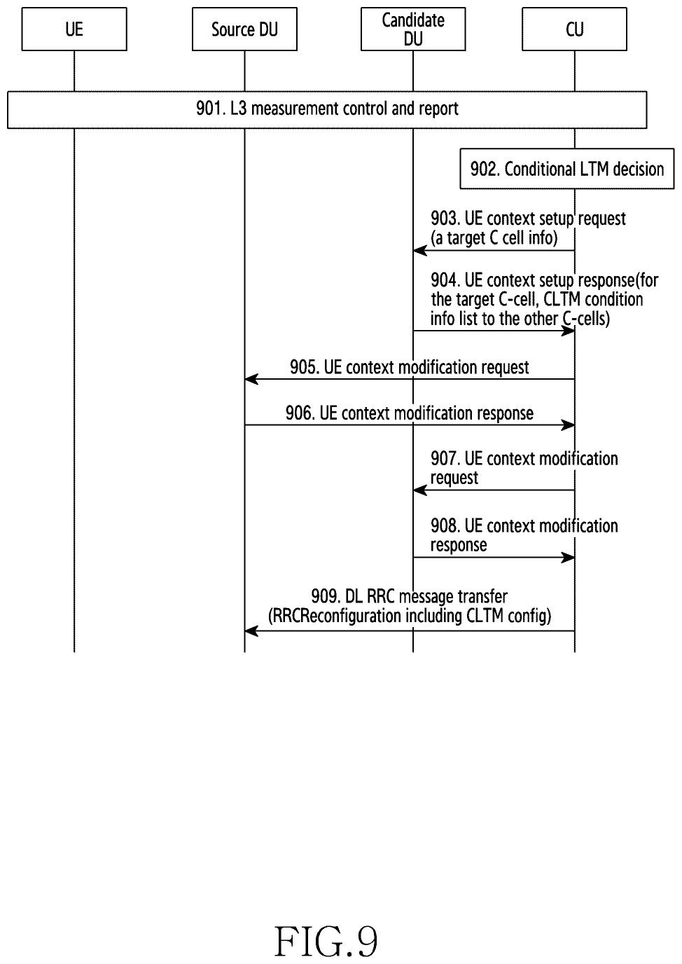

FIG. 9 illustrates a performing operation of a network side according to an embodiment of the disclosure.

In operation 901, the source cell (source DU) may transmit the L3 measurement configuration to UE, and the UE may transfer a measurement result according to the configuration to the CU through the source cell.

In operation 902, the CU may determine a candidate target cell which may derive the conditional LTM configuration, based on the received measurement result.

In operation 903, the CU may transmit a UE context setup request message to the candidate DU (the candidate gNB-DU(s)). UE CONTEXT SETUP REQUEST for each CLTM candidate cell may include one target candidate cell ID, a CLTM configuration ID of the candidate cell, a CLTM configuration ID mapping list, and a CSI resource configuration (Here, the CSI resource configuration may refer to LTM-CSI-ResourceConfigs that are currently configured on the UE, and the purpose thereof is to, after moving to a candidate cell, regard the corresponding cell as a serving cell, so that when generating L1 measurement target for CLTM, the already generated measurement target can be utilized). The gNB-CU may request PRACH resources from the candidate gNB-DU(s). The gNB-CU may request the candidate gNB-DU to provide the lower layer configuration for the purpose of generating the reference configuration or provide the lower layer reference configuration to the candidate gNB-DU. The gNB-CU may request a PRACH resource from the candidate gNB-DU. The gNB-CU may request a lower layer configuration from the candidate gNB-DU to generate a reference configuration or provide a lower layer reference configuration to the candidate gNB-DU.

Upon receiving the information, the C-DU may consider the target CLTM candidate cell as the source cell and generate condition information, i.e., the measurement target and specific conditions that should be considered when moving with respect to other candidate cells. As one of the CSI-measConfig configuration in CellGroupConfiguration IE, the C-DU may generate the CLTM measurement target and specific condition and include the corresponding information in the UE context setup response message below. The UE context setup request message may include an indicator indicating preparation or initiation of CLTM and cause the C-DU to perform the CLTM condition configuration.

In operation 904, the candidate DU may transmit the UE context setup response message to the CU. The UE context setup response message may include lower layer RRC configurations generated with respect to the target candidate cell. (The message may include CellGroupConfig, measGap config, and the like, and may additionally include CLTM specific early UL sync config and SSB information including SSB Time/Frequency info & PCI, reference config, and complete config indicator. In addition, with the corresponding target candidate cell as the source cell, the message may include the measurement target information and specific conditions for the CLTM targeting each candidate cell, as condition information that should be considered when moving to another LTM candidate cell.)

The UE context setup response message may include an indicator that the message is a response to CLTM or CLTM initiation or CLTM preparation, and the CU receiving the message may know that the message includes condition information for CLTM.

In case that the candidate gNB-DU accept the CLTM configuration request, the gNB-DU may response with a UE CONTEXT SETUP RESPONSE message including the lower layer RRC configuration generated with respect to the accepted target candidate cell.

NOTE 1: The CU initiation UE Context Modification procedure may be initiated by the source gNB-DU to prepare a candidate cell.

Operations 903 and 904 between the CU and another candidate DU may be performed between operations 904 and 905. Accordingly, in operation 905, the transferred information may be collected by the CU.

In operation 905, the CU (gNB-CU) may transmit a UE CONTEXT MODIFICATION REQUEST message to the source DU. The UE CONTEXT MODIFICATION REQUEST message may include information related to early synchronization (RACH information in the candidate cell for early synchronization in the current serving cell or source cell and TCI state information in the candidate cell) and CLTM setup IDs for the accepted target candidate cell(s) in other gNB-DU(s). The CU can transmit an updated CSI resource configuration to the source DU. (Since operations 903 and 904 have been performed with another C-DU, in a state where the SSB information for each C-cell has been acquired, the CU may construct a desired ltm-CSI-ResourcConfig and/or transfer the CSI configuration information for each C-cell itself to the S-DU.). Further, the CU, when each candidate cell constructed from each C-DU is considered as a source cell, may transfer to the S-DU the condition information (constructed after operation 903) that should be considered when moving to the remaining candidate cells.

In operation 906, the source DU may transmit the UE CONTEXT MODIFICATION RESPONSE message to the CU. The UE CONTEXT MODIFICATION RESPONSE message may include an updated lower layer configuration (e.g., including an updated CSI report configuration of the source cell). The lower layer configuration may include condition information for the CLTM that is used based on the current source cell for the CLTM. The CU may receive the information and include the information in the RRCReconfiguration message as the CLTM configuration information.

In operation 907, the gNB-CU may transmit to the candidate gNB-DU a UE CONTEXT MODIFICATION REQUEST message including information for updating the configuration of the subsequent CLTM or candidate cell. In addition, the gNB-CU may provide a lower layer part of the reference configuration to the candidate gNB-DU(s). The gNB-CU may send a UE CONTEXT MODIFICATION REQUEST message to the candidate gNB-DU(s) containing the information for subsequent CLTM or for updating the configurations of candidate cells. The gNB-CU may also provide the lower layer part of the reference configuration to the candidate gNB-DU(s). Additionally, the CU may include condition information, which is used when moving from the source cell created by the S-DU and other C-DUs, in the message in addition to the above information, and transfer the message to the C-DU.

In operation 908, the candidate gNB-DU may transmit the UE CONTEXT MODIFICATION RESPONSE message to the CU. The UE CONTEXT MODIFICATION RESPONSE message may include an updated lower layer configuration (e.g., an updated CSI report configuration).

NOTE 2: Operation 907 may be triggered by execution for the subsequent CLTM.

In operation 909, the gNB-CU may transmit a DL RRC MESSAGE TRANSFER message to the source gNB-DU. The DL RRC MESSAGE TRANSFER message may include an LTM configuration in the generated RRCReconfiguration message.

As an embodiment, when performing event triggered L1 measurement and report other than conditional LTM, the UE may receive a measurement target and a configuration for a reporting condition event from the network, and the UE may perform an evaluation of the measurement and condition.

The evaluation of the condition for the event triggered report may be performed in MAC or PHY. In case that the MAC performs the evaluation, and the reporting is performed according to the event, the evaluation may be performed by a UL MAC CE. In case that the PHY performs the evaluation, the evaluation may be performed through a UCI or PUCCH/PUSCH.

Report contents may include a measured cell and/or a result of measurement of a beam.

When performing an event-triggered report, an average value of measured values on CSI-RS resources in one cell of the UE may be considered as a cell-based value and reported to the base station. In the beam-based case, the UE may report to the base station a time average of the measured values on the CSI-RS resource or an average value over a specific number of samples.

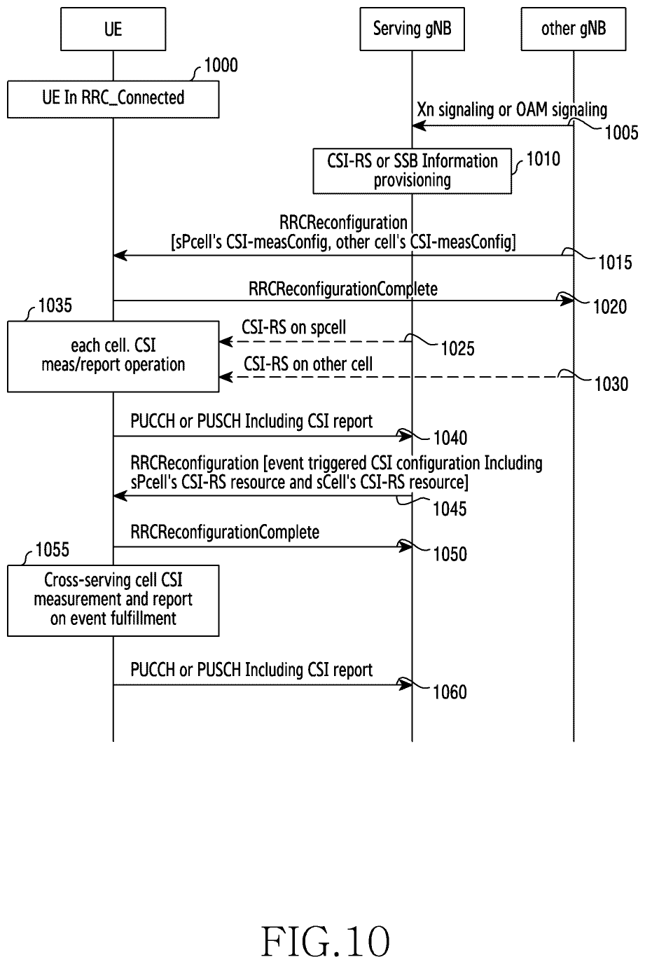

FIG. 10 represents an operating method of a UE and a base station according to an embodiment of the disclosure.

The UE may be configured with the CSI-RS transmitted by a cell thereof from the serving gNB through the CSI-measConfig field for the cell (e.g., spcell) thereof. In addition, the UE may measure the configured CSI-RS and transmit a report according to the report configuration included in CSI-measconfig to a cell (e.g., spcell) thereof. Prior to this, the serving gNB may acquire information about the transmission of SSB and/or CSI-RS operated by each cell with respect to other gNBs in advance. Information related to other base stations may be requested and answered by the serving gNB from neighboring gNBs through an Xn message, or the serving gNB may receive information maintained by the OAM server. In case of the OAM, reception may be performed between the gNB and the OAM server through PUD connection.

For example, the UE, in operation 1000, may exist in an RRC connected state. In operation 1005, the serving base station may receive information about the transmission of SSB and/or CSI-RS operated by each cell from another base station through Sn signaling or OAM signaling. In operation 1010, the serving base station may perform CSI-RS or SSB information provisioning.

A subsequent RRCReconfiguration message may include, for the event triggered CSI meas/report settings, a new measurement target that is a combination of some or the entirety of the RS for CSI transmitted by the serving spcell and some or the entirety of the RS for CSI transmitted by other cells.

According to an embodiment, in operation 1015, the base station may transfer at least one of a CSI measurement configuration of the spcell and a CSI measurement configuration of another cell through the RRCReconfiguration message. The base station may transmit the CSI measurement report configuration in each serving cell together with the measurement configuration.

In operation 1020, the UE having received the RRCReconfiguration message may transmit a RRC reconfiguration complete message to the base station.

In operations 1025 and 1030, the UE may receive CSI-RS from at least one of the serving base station and another base station through the spcell or another cell.

In operation 1035, the UE may receive the information and then measure CSI-RS for each serving cell based on the information. Thereafter, the UE may transmit a report for the measurement to each cell based on the configured report format. For example, in operation 1040, the UE may transmit to the base station a PUCCH or PUSCH including the CSI report.

In an embodiment, in case that an event through measurement is satisfied, the PUCCH or PUSCH may be included in the event triggered CSI configuration in the RRCReconfiguration message for a serving cell that is subject to specific reporting and configured to the UE. Additionally, the RRCReconfiguration message may include, in addition to the configuration for the serving cell, information indicating one of PUCCH or PUSCH or UL MAC CE as the reporting method. According to the indication, the UE may report the measured value to the base station using one of the PUCCH, PUSCH, or UL MAC CE method at the time of reporting.

For example, in operation 1045, the base station may transmit to the UE an RRC reconfiguration message including an event triggered CSI configuration including the CSI-RS resource of the spcell and the CSI-RS resource of the scell.

In operation 1050, the UE having received the RRCReconfiguration message may transmit a RRC reconfiguration complete message to the base station.

In operation 1055, the UE may perform cross-serving cell CSI measurement and reporting, based on the event satisfied. In addition, in operation 1060, the UE may transmit to the base station a PUCCH or PUSCH including the CSI report.

In an embodiment, the measurement targets may be configured to the UE using a separate ID such as an event triggered CSI-resource config ID.

In another embodiment, an operation of the conditional LTM may be used in a system for saving network energy. From the perspective of network energy saving (NES), a specific cell may operate, as an NES operation, in cell DTX/DRX and/or in a time domain energy saving mode or frequency domain energy saving mode in the physical layer. In this case, specific UEs may not want to be served in the NES mode, and the network may recognize such UEs based on judgment of its own. For this, the network may collectively move the UEs to other cells when changing to the NES mode. In the case where there are multiple such UEs, the conventional handover (HO) method transfers a HO command for each UE, which may consume radio resources on multiple Uu interfaces, and therefore, there may be resource constraints in the concurrent schedule, and it may be difficult to specify the exact time of execution of the NES mode operation in the corresponding serving cell. To avoid this problem, the base station may indicate to the UEs that the base station is entering the NES mode through a common L1 signal, e.g., a specific DCI type, via the serving cell. Prior to this, UEs that do not want to use the NES mode may be preconfigured by the network with information such as RNTI, which enables decoding of common LI signaling at all times. After receiving the NES mode entry signal from the base station, the UEs having received this information may perform an LTM cell switch to one of the cells that satisfies the condition through evaluation of the condition of the conditional CLTM thereof.

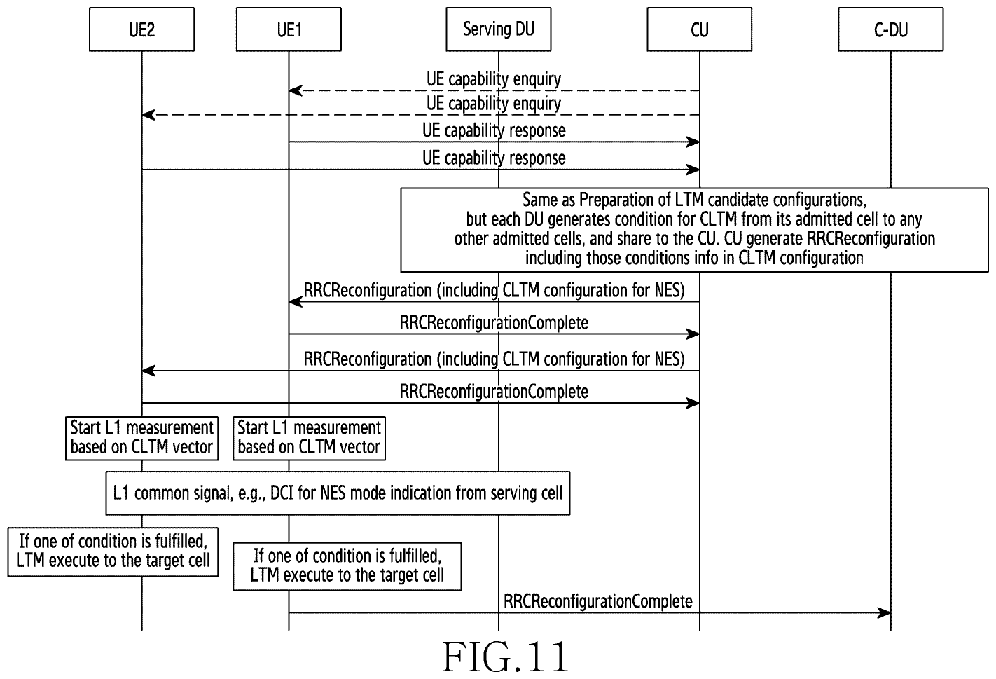

FIG. 11 illustrates an example of applying conditional LTM to a NES mode according to an embodiment of the disclosure.

The network (serving cell) may request capability information from the UE. For this, the UE may transmit to the network a capability repose message including capability information of CLTM for NES.

In the network knowing that the UE is capable of NES capable CLTM, the CU, the serving DU, and the candidate DU (C-DU) may configure a conditional LTM candidate configuration. In this procedure, each serving DU may generate the condition information of the CLTM for moving to another candidate cell, using a cell of the serving DU as the source cell. Here, in case of preparing the CLTM, or transferring the condition information determined in connection with the CLTM, and the target cell information to the CU and S-DU, an indicator separately indicating that the information is for the NES may be associated and included in the corresponding F1 and Xn messages.

The CLTM configuration information generated thereafter may be transferred to the UE as follows.
Spcell of the serving DU may transfer the RRCReconfiguration message including the CLTM configuration information to the UE. Here, an indicator indicating the NES mode may be included in the message. In addition, RNTI information to decode the DCI, which is the NES mode indicator, may be also included in the message.
The UE may receive the message and perform following operations.

1. The UE may receive the CLTM configuration from the CU through the RRCReconfiguration message.

The UE may identify that there is the CLTM configuration, store the CLTM configuration, and start measurement based on the measurement target associated with each candidate cell for L1 measurement. (Optionally, if there is an indicator in the REPORTTYPE for CLTM that indicates that dynamic activation of the measurement is possible, the UE may perform the measurement when the activation signal of the measurement for CLTM is received through DCI or DL MAC CE on the network after the RRCReconfiguration message.)

The UE may start evaluating the provided condition as soon as starting the measurement. However, a cell switch may not be performed even if the conditions are satisfied until the NES mode indicator below is received.

2. In case that the UE receives an L1 signal (i.e., a specific type of DCI) indicating the NES mode entering in the serving cell, the UE may decode the DCI and thereafter, if the condition of CLTM for NES is satisfied, may apply the target configuration of the CLTM candidate cell associated with that satisfied condition. That is, the handover with respect to the CLTM candidate cell may be performed.

3. The UE, after performing RACH (RA based), may transfer a complete message to the target cell or perform initial UL data transmission (RACH-less).

4. End

The network side may perform the following operations.
CLTM preparation procedure in the network (assuming intra-CU)

Each DU in CU generates the condition for CLTM for the case from this DU's admitted cell to any other cells admitted for LTM. Each DU in CU may generate the condition for CLTM for the case from this DU's admitted cell (LTM source cell) to another cell (LTM candidate target cell) admitted for LTM.

In detail, once each DU get to know the all the other admitted cells, then condition from one of its admitted cells to all the other admitted cell should be generated by this DU. And the condition info (the measurement target or the specific condition, or a combination of the measurement target and the specific condition) should be shared to the CU. In detail, once each DU gets to know the admitted cells from the other DUs (or with respect to the admitted cell allowed to be known), the DU may generate a condition for the handover from one of cells admitted to the DU (LTM source cell) to a cell (LTM candidate target cell) admitted from other DUs. In addition, the generated condition information (the measurement target or the specific condition, or a combination of the measurement target and the specific condition) may be shared to the CU.

CU include those condition info and the associated CLTM target cell info into the CLTM configuration in RRCReconfiguration. The CU may include “specific condition information and/or CLTM measurement target information associated therewith” with respect to such target candidate cell into CLTM configuration of the RRCRecfiguration message. Thereafter, the CU may transmit the RRCReconfiguration message including the CLTM configuration to the UE.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented.

Also, the above respective embodiments may be employed in combination, as necessary. For example, a part of one embodiment of the disclosure may be combined with a part of another embodiment to operate a base station and a terminal. In addition, the embodiments of the disclosure may be applied to other communication systems and other variants based on the technical idea of the embodiments may also be implemented. For example, the embodiments may be applied to LTE, 5G, NR, or 6G systems. Therefore, the scope of the disclosure should not be defined as being limited to the embodiments set forth herein, but should be defined by the appended claims and equivalents thereof.

The specific example for explaining the embodiments according to the disclosure is merely a combination of the respective criteria, detailed methods, and operations, and the UE or base station may perform an artificial intelligence-based handover operation in a next-generation mobile communication system through a combination of at least two of the described various techniques. Furthermore, the handover operation may be performed through one of the above-described techniques or a combination of at least two thereof. For example, some of operations of one embodiment may be performed in combination with some of operations of another embodiment.

The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. As an example, the “non-transitory storage medium” may include a buffer in which data is temporarily stored. According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store, or between two user devices (e.g., smart phones) directly. If distributed online, at least a part of the computer program product (e.g., a downloadable app) may be temporarily generated or at least temporarily stored in the machine-readable storage medium, such as memory of the manufacturer's server, a server of the application store, or a relay server.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station (BS) on a serving cell, configuration information on a conditional lower layers triggered mobility (CLTM);
performing a measurement on cells, based on the configuration information; and
performing a handover to one cell of the cells, based on a result of the measurement.

2. The method of claim 1,
wherein the configuration information includes a first condition associated with a handover, and
wherein the first condition represents that a beam strength of one cell of the cells is greater than a beam strength of the serving cell by a first value or more.

3. The method of claim 2,
wherein the configuration information includes a second condition associated with a handover, and
wherein the second condition represents that a signal strength of one cell of the cells is greater than a signal strength of the serving cell by a second value or more.

4. The method of claim 3,
wherein the BS includes a distributed unit (DU), and
wherein the first condition and the second condition are generated in the DU.

5. The method of claim 3,
wherein the configuration information is received via a radio resource control (RRC) reconfiguration message, and
wherein, in case that the result of the measurement meets the first condition or the second condition, the handover is performed.

6. A method performed by a distributed unit (DU) on a serving cell in a wireless communication system, the method comprising:
transmitting, to a central unit (CU), condition information on a conditional lower layers triggered mobility (CLTM); and
transmitting, to a user equipment (UE), configuration information including the condition information.

7. The method of claim 6,
wherein the condition information includes a first condition associated with a handover of the UE, and
wherein the first condition represents that a beam strength of one cell of the cells is greater than a beam strength of the serving cell by a first value or more.

8. The method of claim 7,
wherein the condition information further includes a second condition associated with the handover of the UE, and
wherein the second condition represents that a signal strength of one cell of the cells is greater than a signal strength of the serving cell by a second value or more.

9. The method of claim 8, further comprising:
generating the first condition and the second condition.

10. The method of claim 6, wherein the configuration information is transmitted via a radio resource control (RRC) reconfiguration message.

11. A user equipment (UE) in a wireless communication system, the UE comprising:
a transceiver; and
a controller coupled with the transceiver and configured to:
receive, from a base station (BS) on a serving cell, configuration information on a conditional lower layers triggered mobility (CLTM),
perform a measurement on cells, based on the configuration information, and
perform a handover to one cell of the cells, based on a result of the measurement.

12. The UE of claim 11,
wherein the configuration information includes a first condition associated with a handover, and
wherein the first condition represents that a beam strength of one cell of the cells is greater than a beam strength of the serving cell by a first value or more.

13. The UE of claim 12,
wherein the configuration information includes a second condition associated with a handover, and
wherein the second condition represents that a signal strength of one cell of the cells is greater than a signal strength of the serving cell by a second value or more.

14. The UE of claim 13,
wherein the BS includes a distributed unit (DU), and
wherein the first condition and the second condition are generated in the DU.

15. The UE of claim 13,
wherein the configuration information is received via a radio resource control (RRC) reconfiguration message, and
wherein, in case that the result of the measurement meets the first condition or the second condition, the handover is performed.

16. A base station (BS) in a wireless communication system, the BS comprising:
a transceiver; and
a controller coupled with the transceiver and configured to:
transmit, to a central unit (CU), condition information on a conditional lower layers triggered mobility (CLTM), and
transmit, to a user equipment (UE), configuration information including the condition information.

17. The BS of claim 16,
wherein the condition information includes a first condition associated with a handover of the UE, and
wherein the first condition represents that a beam strength of one cell of the cells is greater than a beam strength of a serving cell by a first value or more.

18. The BS of claim 17,
wherein the condition information further includes a second condition associated with the handover of the UE, and
wherein the second condition represents that a signal strength of one cell of the cells is greater than a signal strength of the serving cell by a second value or more.

19. The BS of claim 18, wherein the controller further configured to:
generate the first condition and the second condition.

20. The BS of claim 16, wherein the configuration information is transmitted via a radio resource control (RRC) reconfiguration message.
